(19) United States
(12) Patent Application Publication
(10) Pub. No.: US 2005/0116020 A1
(43) Pub. Date: Jun. 2, 2005

(54) Locating individuals and games in a gaming establishment

(76) Inventors: Walter E. Smolucha, Melrose Park, IL (US); Mark Gagner, West Chicago, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/703,394

(22) Filed: Nov. 7, 2003

(51) Int. Cl. G06F 17/00

(52) U.S. Cl. 235/375; 340/539.13; 463/25; 340/572.1

(57) ABSTRACT

This application describes, among other things, a plurality of casino games located in a gaming establishment wherein at least some of the games include a reader component that detects a RFID tag in proximity to the reader component and produces detection information indicative at least in part of the detection of a particular one of a RFID tag carried by an individual in the gaming establishment. An information system includes software operable on the system to record information concerning the movement and activities of an individual in a gaming establishment as determined from reading individual RFID tags by the reader components. According to an alternate embodiment, games include RFID tags that can be detected by other games using the RF reader component. Accordingly, the information system can determine the location and movement of an individual through a gaming establishment, as well as determine which games are in proximity to each other where such games are outfitted with a RFID tag.

### TECHNICAL FIELD OF THE INVENTION

The present invention pertains generally to casino gaming, and more particularly to methods, systems, and software for tracking individuals in a gaming establishment.

### BACKGROUND OF THE INVENTION

The gaming industry has grown increasingly competitive and sophisticated in recent years. As such, it has become increasingly important to deliver the highest possible quality of gaming experience for each and every player. This both assures that the player will have a satisfying experience and that the gaming establishment has the best possible chance to maximize revenue and profit from each player. Described below are various embodiments of the inventive subject matter hereof that may, among other things, assist in improving a player's experience in a gaming establishment and also in enhancing a gaming establishment's profit or retention of that player.

### BRIEF DESCRIPTION OF THE DRAWING

FIGS. 1-9 illustrate various system embodiments of the inventive subject matter disclosed herein.

FIGS. 10-16 illustrate various method embodiments of the inventive subject matter disclosed herein.

### DETAILED DESCRIPTION OF THE INVENTIVE SUBJECT MATTER

In the following detailed description of the embodiments of the inventive subject matter, reference is made to the accompanying drawings that form a part hereof, and in which is shown by way of illustration specific embodiments in which the inventive subject matter may be practiced. These embodiments are described in sufficient detail to enable those skilled in the art to practice the inventive subject matter, and it is to be understood that other embodiments may be utilized and that changes may be made without departing from the scope of the present inventive subject matter. The following detailed description is, therefore, not to be taken in a limiting sense, and the scope of the present inventive subject matter is defined only by the appended claims.

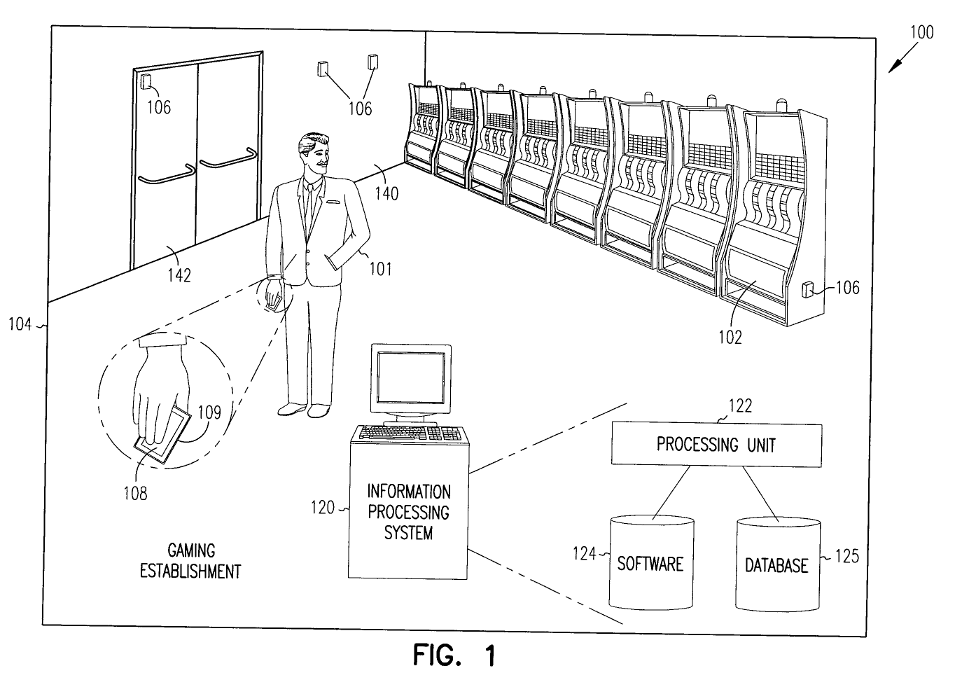

Referring now to FIG. 1 there is illustrated in block diagram form of a system 100 according to a first example embodiment of the inventive subject matter disclosed herein. System 100 is capable of tracking individuals 101 in a gaming establishment 104 such as a casino in which a number of casino games 102 are deployed. The individuals are provided with and carry or wear a radio frequency identification (RFID) tags 108. RFID tags 108 may be, for example, embedded or mounted in a plastic carrier 109, such as a picture identification card. A RFID tag 108 is, in one example embodiment, capable of emitting one or more signals that can be used by a reader component 106 mounted in or on or proximate a casino game 102. The reader component may be mounted in the vicinity of casino games on a wall 140 or doorway 142 or other structure such as a lighting fixture, a ceiling or a structural support column. The reader component reads the RFID tag 108 and obtains information stored in the tag that can be used to uniquely identify it. Accordingly, when an individual 101 brings a RFID tag 108 into proximity to a reader component 106, the reader component 106 detects one or more signals from the device 108. The reader component 106 in turn generates one or more signals or data that is indicative of the identity of the RFID tag. Thus, by virtue of knowing the location of the reader component 106, the location of the RFID tag 108 can be ascertained. A system 120 is provided for processing and recording data collected from RFID tags 108, as described in more detail below.

As used herein, the term casino game encompasses, without limitation, slot machines, video poker machines, roulette tables, poker tables, craps tables and any other game of chance offered by a gaming establishment wherein for example the game qualifies as regulated and/or licensed gaming equipment. The term gaming establishment refers to an establishment that offers casino gaming experiences to its patrons and, in one example embodiment, is licensed by a gaming regulatory authority to provide such gaming experiences.

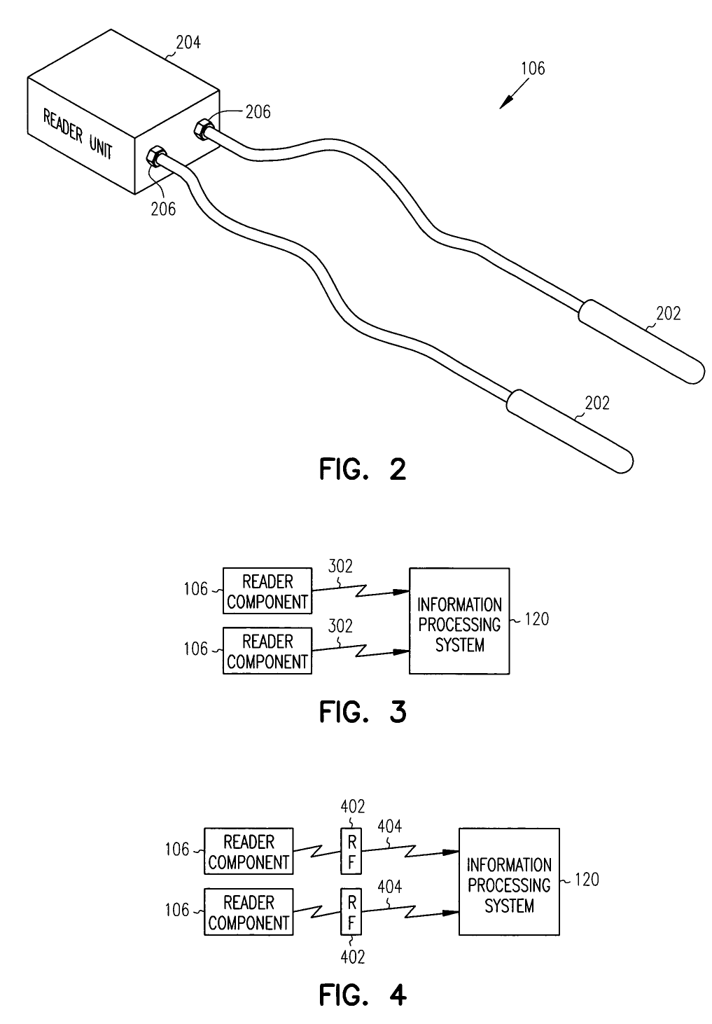

As illustrated in FIG. 2, the reader component 106 positioned in or on the game 102 (or on a wall, doorway or other structure) may be a reader unit 204 that supports at least one antenna 202 that is co-located with the unit 204, such as the stationary reader model RDR-001, sold by Matrics, Inc., of Columbia, Md., U.S.A. The antenna 202 may be the general purpose antenna model number ANT-001 also available from Matrics, Inc. In the alternative, a reader unit 204 may support two or more antennas 202 that are located remotely from unit 204. RFID tag 108 may be, for example, the EPC Version 1 UHF RFID tag available from Matrics, Inc.

Radio frequency identification, or RFID, is a generic term for technologies that use radio waves to automatically identify individual items. There are several methods of identifying objects using RFID tags, such as tags 108. One of the most common is to store a serial number that identifies an item, thing, or person (such as an individual carrying an RFID tag 108), and perhaps other information, on a microchip that is attached to an antenna (the chip and the antenna together are called an RFID transponder or an RFID tag). The antenna enables the chip to transmit the identification information to a reader. The reader converts the radio waves returned from the RFID tag into a form that can then be passed on to, for example the system 120, that can make use of it. While it depends on the particular RFID tag and the application, one example embodiment of a RFID tag 108 carries about 2 KB of data—enough to store some basic information about the item or person it represents.

As described in various configurations below, an RFID system such as system 101 may comprise a RFID tag 108, which is made up of a microchip with, for example, a coiled antenna, and an interrogator or reader with an antenna, referred to herein in some instances as a reader component 106 generally, or more specifically as may be provided in some embodiments as a reader unit 204 and antenna 202. reader unit 204 may include an integral or co-located antenna, or it may be deployed with one or remote antennas deployed at some distance from the unit 204. Remote antennas may be coupled to the reader unit 204 with a wireline connection. The reader 204 generates electromagnetic waves from the antenna 204 that form a magnetic field when they “couple” with the antenna on the RFID tag. According to one example embodiment, system 101 or other embodiments herein below described use passive tags that have no battery. These passive tags draw power from the reader, which sends out electromagnetic waves that induce a current in the tag's antenna. The RFID tag draws power from this current and uses it to power the microchip's circuits. The chip then modulates the waves that the tag sends back to the reader and the reader converts the new waves into digital data. Most passive RFID tags simply reflect back waves from the reader. Energy harvesting, on the other hand, is a technique in which energy from the reader is gathered by the tag, stored momentarily, and transmitted back at a different frequency.

According to another example embodiment of the RFID tags 108, there are provided active RFID tags that have a battery, which is used to run the microchip's circuitry and to broadcast a signal to a reader (for example like the way a cell phone transmits signals to a base station). Semi-passive tags can also be used in the embodiments herein, and use a battery to run the chip's circuitry, but communicate by drawing power from the reader. Active and semi-passive tags are useful for tracking items that need to be scanned over long ranges, but they cost more than passive tags. The read range of passive tags may not be as far as active tags, for example for some example technology, less than ten feet as opposed to one-hundred (100) feet or more for active tags. More particularly, the read range of passive tags depends on many factors: the frequency of operation, the power of the reader, interference from metal objects or other RF devices. In general, low-frequency tags are read from a foot or less. High frequency tags are read from about three feet and UHF tags are read from 10 to 20 feet. Where longer ranges are needed, active tags use batteries to boost read ranges to 300 feet or more.

Radio frequency identification in system 101 does not require line of sight. RFID tags can be read as long as they are within range of a reader. Radio waves travel through most non-metallic materials, allowing RFID tags or the readers to be embedded in packaging or encased in protective plastic for weather-proofing and greater durability. Or, in the alternative, the reader component 106 can be mounted in a housing provided that the radio waves can traverse the housing, either by going through a wall, window or opening in the housing. However, reading an RFID through a metallic barrier can be more difficult.

RFID tags and readers have to be tuned to the same frequency to communicate. RFID systems can use many different frequencies, but generally the most common are low- (around 125 KHz), high- (13.56 MHz) and ultra-high frequency, or UHF (850-900 MHz). Microwave (2.45 GHz) is also used in some applications. Different frequencies have different characteristics that make them more useful for different applications. For instance, low-frequency tags are cheaper than ultra high frequency (UHF) tags, use less power and are better able to penetrate non-metallic substances. UHF frequencies typically offer better range and can transfer data faster. But they use more power and are less likely to pass through materials. And because they tend to be more “directed,” they may require a clear path between the tag and reader.

System 101 and other embodiments disclosed herein may be implemented with read-write or read-only RFID tags 108. With read-write chips, an application can add information to the tag or write over existing information when the tag is within range of a reader, or interrogator. Some read-only microchips have information stored on them during the manufacturing process. The information on such chips can never be changed. Another option is to use electrically erasable programmable read-only memory, or EEPROM. With EEPROM, the data can be overwritten using a special electronic process.

It is noted that one problem encountered with RFID is the signal from one reader can interfere with the signal from another where coverage overlaps. This is called reader collision. One way to avoid the problem is to use a technique called time division multiple access, or TDMA. In simple terms, the readers are instructed to read at different times, rather than both trying to read at the same time. This ensures that they don't interfere with each other. But it means any RFID tag in an area where two readers overlap will be read twice. Accordingly, in one example embodiment of the systems and methods described hereinabove, the system or method is operated so that if one reader reads a tag another reader does not read it again. Another problem readers have is reading a lot of RFID tags in the same field. Tag collision occurs when more than one chip reflects back a signal at the same time, confusing the reader. Different vendors of RFID technology have developed different systems for having the tags respond to the reader one at a time. Since they can be read in milliseconds, it appears that all the tags are being read simultaneously.

As illustrated in FIG. 1, reader component 106 is configured to communicate with an information system 120 through a communication channel 130. Information system 120 may be disposed in the gaming establishment 104 or at a remote site. System 120 includes at least one processing unit 122 and software 124 operable on the system to record and process data read from RFID tags 108 as read by the tag reader components 106. Through the processing of this data and using other stored data, system 120 can track the position of an individual 101 in the gaming establishment 104 and determine which games 102 the individual 101 is playing and for how long. To provide this functionality, software 124 additionally operates to maintain a database 125 of records representing individuals 101, reader components 106 and the casino game they are associated with, RFID tags 108 and the individuals they are assigned or associated with, and the location of RFID tag 108 over a desired period of time. Accordingly, the recorded RFID location information (as determined by the detection of such RFID tags at a casino game 102 or wall 140 or doorway 142 or other structure allows system 120 to track the location, movement, and game play of an individual 101 in the casino.

As noted above, data transmission system 130 provides for conveying data from or between the reader components 106, such as a reader unit 204, to the information system 120. According to one alternate embodiment shown in FIG. 3, the data transmission system 130 comprises physical connectors 302 connecting the information system 120 to the reader component 106, such as through an Ethernet connection. According to another alternate embodiment illustrated in FIG. 4, the data transmission system 130 comprises RF transmission components 402 passing data between the reader component 106 and the information system 120 using radio frequency transmissions 404. According to another embodiment, the wireless communication may take the form of infra-red or any other wireless or wireline communication technique or format.

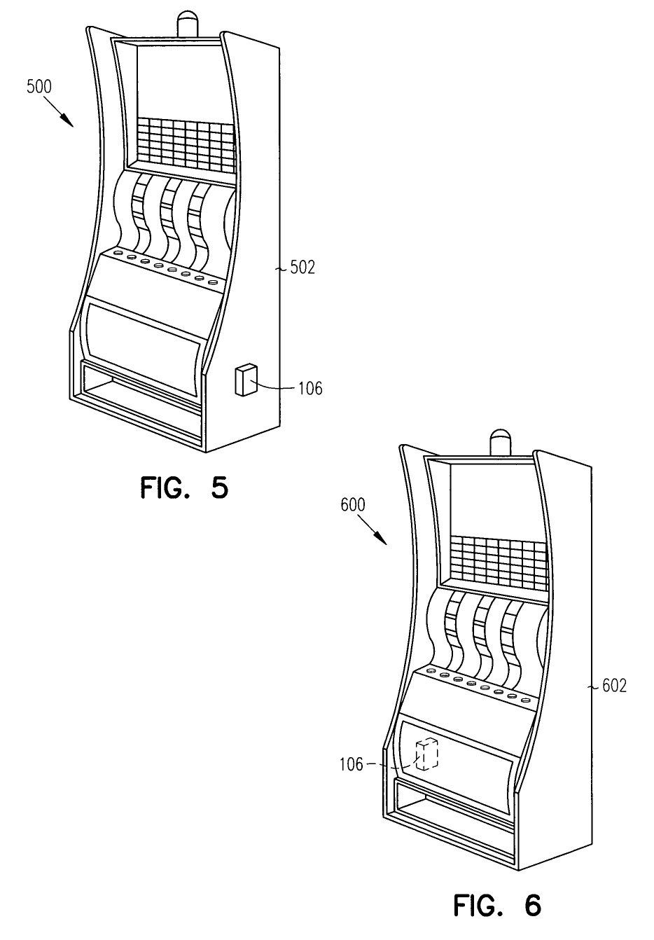

Referring now to FIG. 5, there is illustrated an embodiment 500 in which the reader component 106 is located on the side 502 of a housing of a casino game 504. In the alternate embodiment 600 shown in FIG. 6, a reader component 106 is located within the housing 602 of the casino game 604. In either embodiment 500 or 600, the reader component 106 can either be an antenna 202 alone, with the reader unit 204 located remotely from the casino game, or the reader component 106 can be a reader unit 204 that includes an antenna 202.

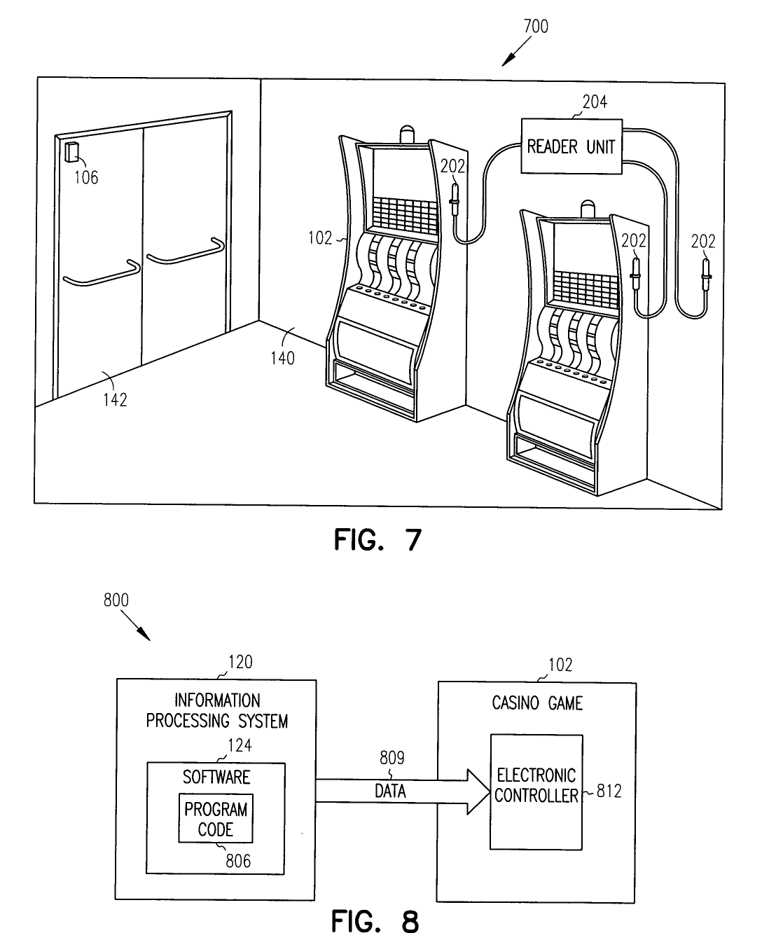

As illustrated in FIG. 7, in one example embodiment 700 according the inventive subject matter disclosed herein, a reader unit 204 receives input from a plurality of antennas 202, wherein the antennas are located in two or more different casino games 102.

Referring now to FIG. 8, there is illustrated an alternate embodiment 800 wherein the software 124 operable on information system 120 includes program code 806 that may have the capability of sending game play control instructions or data 809 to the one or more casino games 102. Games 102 may include an electronic controller 812 (including for example a programmed computer) adapted to be responsive to instructions or data 809 from a remote system such as system 120 to control the operation of the game 102.

In yet another alternate embodiment, program code 806 is operable on system 120 for recording the individual's game playing history in one or more records in a database 125. In a further alternate embodiment of the system of FIG. 8, program code 806 is capable of sending instructions to a casino game 102 to alter game play for an individual 101 in response to the detection of an individual at the game 102, as determined by detecting a RFID tag 108 carried by the individual 101. In yet another alternate embodiment illustrated by FIG. 8, program code 806 may be configured to work with a RFID tag 108 that is part of a token or machine readable card 810 an individual uses in connection with playing casino games. For example, card 810 may include a magnetic strip or smart card components.

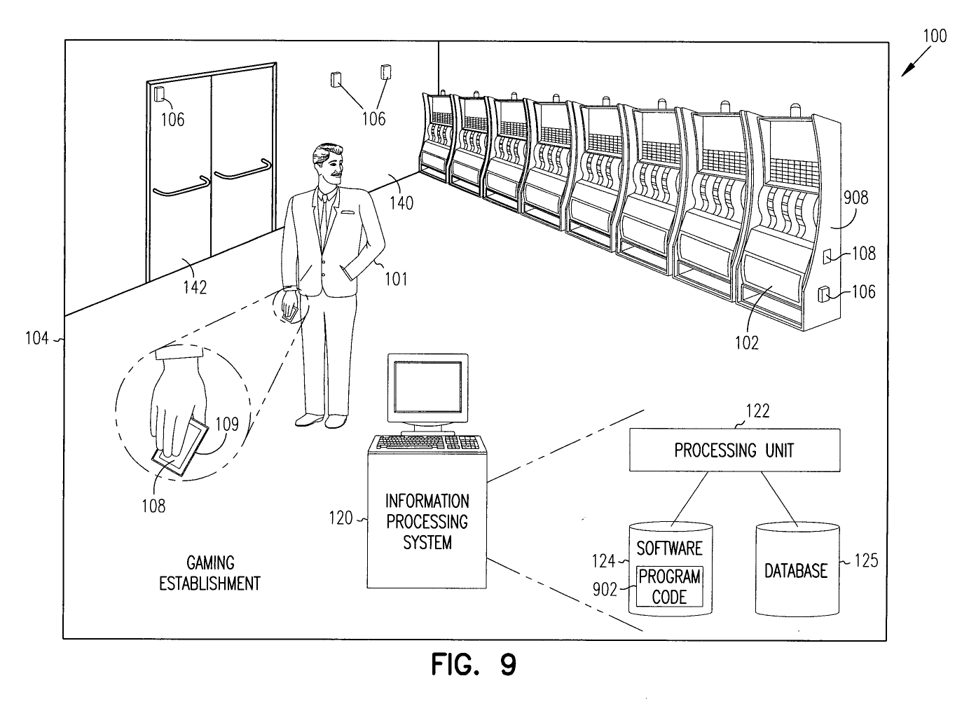

In further alternate embodiments of the inventive matter described herein shown in FIG. 9, a reader component 106 may be mounted in a casino game 102 to facilitate RF radiation traversing the game housing, such as through the belly glass of the game. As also shown in FIG. 9, in an alternate embodiment a RF reader component 106 may be situated on the side 908 of a casino game 102.

Referring again to FIG. 9, there is illustrated still another alternate embodiment 900. In embodiment 900, at least some of the casino games 102 additionally include a RFID tag 108 mounted on or in the games 102. In this embodiment, the RF reader components 106 in a game 102 can detect the presence of a RFID tag 108 in or on another game 102. In this embodiment, software 124 in system 120 includes program code 902 capable of maintaining one or more records that indicate the association of a RFID tag 108 with a particular game 102, and thereby determine which other games 102 having RFID tags 108 that are near the particular game 102. The reader component 106, in this and other embodiments, may also be configured to determine the direction from which an identified RFID tag 108 emission is emanating, providing some directional information that can be used to determine the relative orientation of a detected game or individual with regard to the detecting component 106. Still further, in this alternate embodiment, program code 902 keeps records of casino games 102 and associated RFID tags 108. Accordingly, based on the detection by a first game 102 of nearby games 102 having RFID tags 108, software 124 can determine which casino games are in proximity with one another. In yet another alternate embodiment of the above, program code 902 is capable of sending instructions to the individual casino games 102 so that the game play can be altered based on the proximity of casino games 102 to each other as determined by reading the RFID tags 108 and also based on the detection of a particular individual 101 near or at a game 102. This embodiment enables casino games in proximity to each other to act in concert, and to offer complimentary game play or coordinated game play. Accordingly, a player 101 may be presented with game play options on nearby games 102 that are customized for or known or thought to be desirable for the player 101.

Referring to FIG. 12, a first method 1000 according to the inventive subject matter disclosed herein is described. Method 1000 includes providing a tracking device including a RFID tag to an individual in a gaming establishment, as illustrated in flow chart item 1002. The individual carries the RFID tag with him or her as they play games in the gaming establishment, as represented by flow chart block 1004. As shown in flow chart item 1006, a RFID tag reader situated in or near a casino game is used to detect an individual in proximity to a casino game.

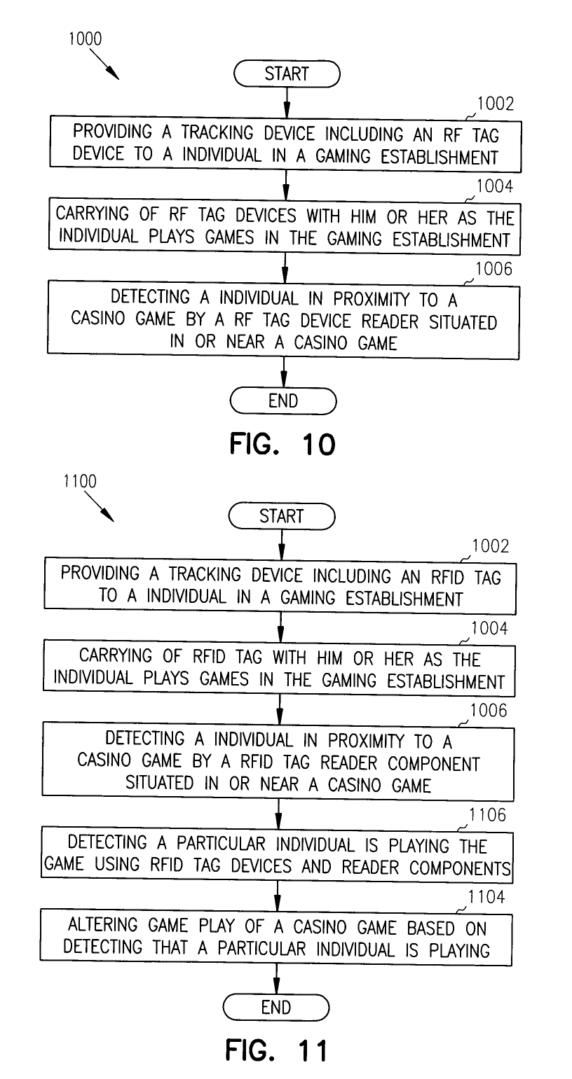

According to one alternate embodiment of method 1200, an individual is detected in proximity to a casino game whether or not the individual plays the game. According to yet another alternate embodiment, an individual's game playing history is recorded based on the detection of a RFID tag carried by the individual as he or she plays casino games. In another alternate embodiment of FIG. 10, method 1000 further includes data transmission method whereby physical connectors connect the information method to the reader components, or RF transmission components pass data between the reader components and the information method using radio frequency transmissions.

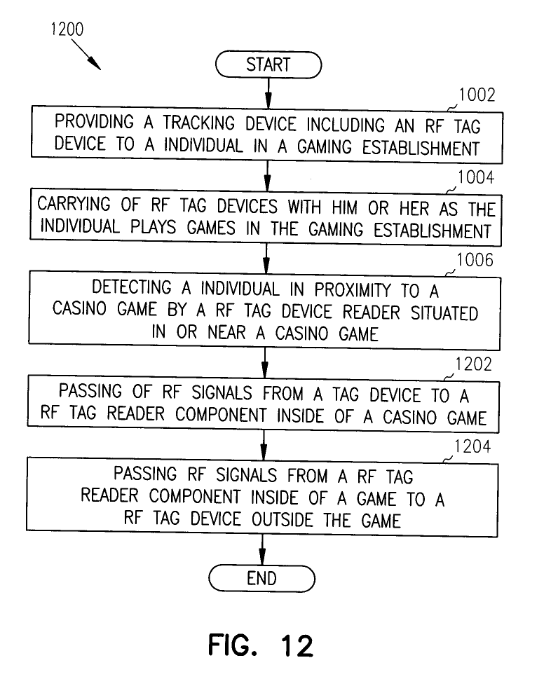

In still a further alternate embodiment shown as method 1100 in FIG. 11, the game play of a casino game is altered, as indicated by flow chart item 1104, based on detecting that a particular individual is playing the game as detected using the RFID tags and RF reader components, as illustrated by flow chart item 1106.

According to one alternate embodiment, the casino game that is altered is at least in part an electronically controlled game such that game play commands and data may be sent to the game through a signal conveyance in order to alter game play.

According to still another example embodiment of the methods of the inventive subject matter described herein, a RFID tag is part of a token or machine readable card an individual uses in connection with playing in the casino or playing a casino game. For example, the RFID tag may be part of an identification card or a credit or debit card the player is provided by the gaming establishment.

Referring now to FIG. 12, there is illustrated yet another method embodiment 1200 in which RF signals are passed from a RFID tag, as indicated as flow chart item 1202, to a RF reader component inside of a casino game, or, as indicated by item 1204, from a RF reader component inside of a game to a RFID tag outside the game and for example carried by an individual in a gaming establishment. According to one example embodiment of the method, the RF signals are passed through the belly glass or other RF permeable portion of a casino game.

Another alternate embodiment of the method 1200 further includes another block facilitating RF radiation traversing the game housing by situating the reader component in the casino game. In a yet another alternate embodiment of FIG. 12, further includes situating the RFID tag reader on the top of a casino game.

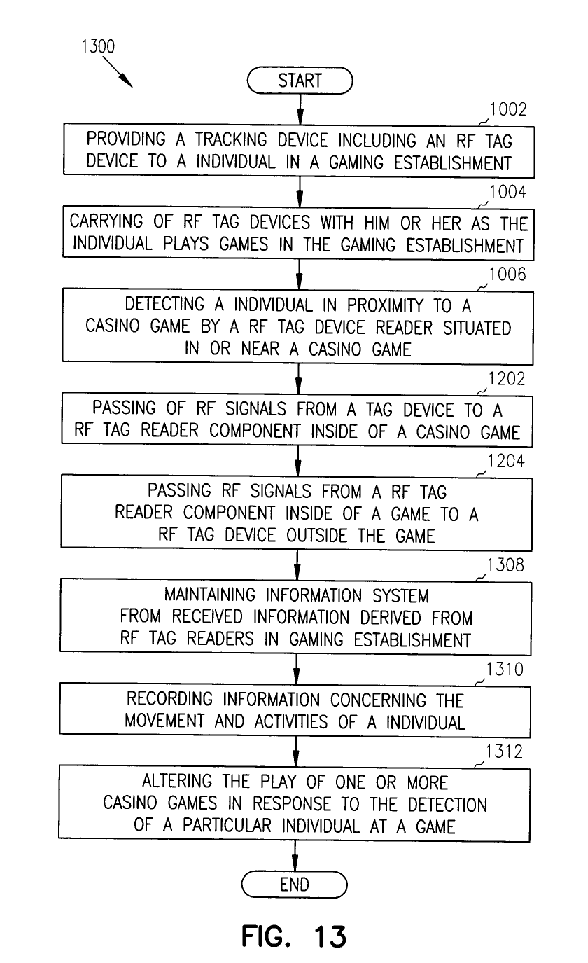

In a further alternate embodiment depicted as method 1300 in FIG. 13, the method of FIG. 12 further includes maintaining data in an information system from received information derived from the RFID readers in the gaming establishment, as depicted in block 1308. This method 1300 further includes recording information concerning the movement and activities of an individual as depicted by block 1310, as determined from reading individual RFID tag by the reader components. Method 1300 further includes, as depicted by block 1312, altering the play of one or more casino games in response to the detection of a particular individual at a game.

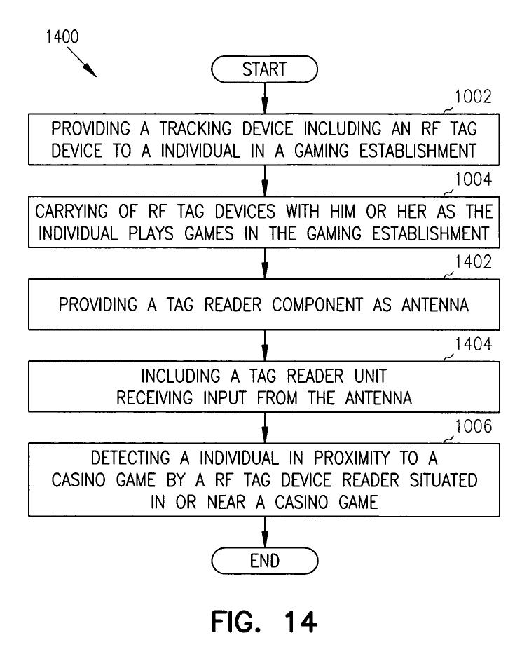

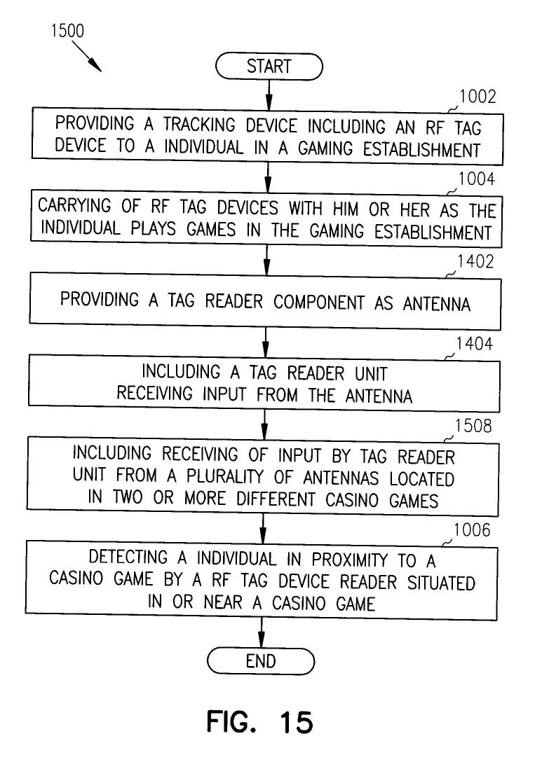

In yet another alternate embodiment of method 1000 illustrated as method 1400 in FIG. 14, block 1402 depicts providing the reader component as an antenna. Bock 1404 depicts including a reader unit receiving input from the antenna. In further alternate embodiment of method 1400, the reader unit is located inside the casino game, or outside of the casino game.

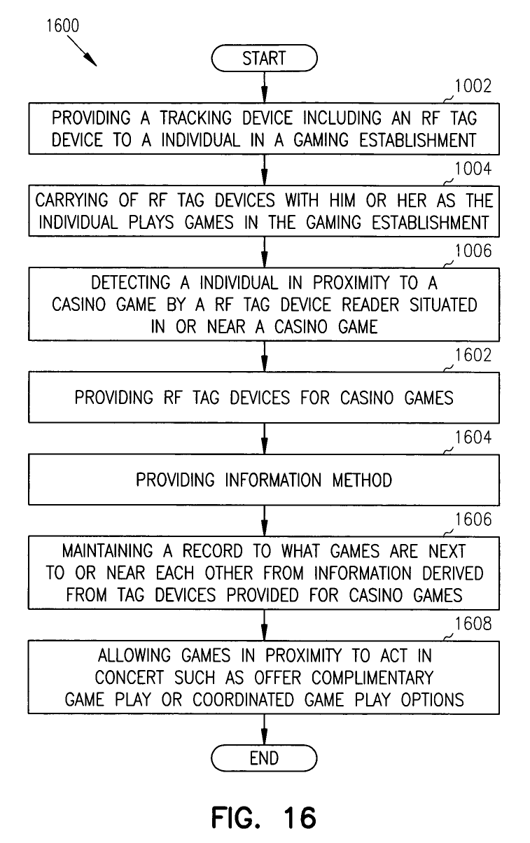

In another alternate embodiment of method 1400, FIG. 15 shows method 1500, which includes receiving input by the reader unit from a plurality of antennas located in two or more different casino games as depicted by block 1508.

In an alternate embodiment 1600 illustrated in FIG. 16, the method 1000 further includes providing RFID tags for the casino games, as depicted by item 1602. As also illustrated as another further alternate embodiment, the method further includes, as indicated by item 1604, maintaining a record of what games are next to or near to each other from information derived from tag devices associated with or in or on the casino games, as depicted by item 1606 on the flow chart. The method further may provide for allowing games in proximity to act in concert such as offer complimentary game play or coordinated game play options, as depicted by item 1608 on the flow chart.

There is described above a number of embodiments of inventive subject matter wherein RFID tags are used to locate or establish a position of an individual or a casino game.

1. A system comprising:
a plurality of casino games located in a gaming establishment wherein at least some of the games include a reader component adapted to detect a RFID tag in proximity to the reader component and read data from the RFID tag, wherein the RFID tag is carried by an individual in the gaming establishment; and
an information system including software operable on the system to record information concerning the movement and activities of an individual in a gaming establishment as determined from reading the RFID tag carried by the individual in the gaming establishment.

2. A system according to claim 1 further including a data transmission system connecting the reader component to the information system and wherein the transmission system comprises physical connectors connecting the information system to the reader components.

3. A system according to claim 1 further including a data transmission system connecting the reader component to the information system and wherein the transmission system comprises RF transmission components passing data between the reader components and the information system using radio frequency transmissions.

4. A system according to claim 1 wherein the reader component is an antenna.

5. A system according to claim 4 further wherein the reader component includes a reader unit receiving input from the antenna.

6. A system according to claim 5 further wherein the reader unit is located in the casino game.

7. A system according to claim 5 further wherein the reader unit is located outside of the casino game.

8. A system according to claim 4 further including a reader unit receiving input from a plurality of antennas wherein the antennas are located in two or more different casino games.

9. A method comprising:
providing a RFID tag to an individual in a gaming establishment;
the individual carrying the RFID tag with him or her as they move about or play games in the gaming establishment; and
using a RFID tag reader component situated in or near a casino game to receive information from the RFID tag.

10. A method according to claim 9 further including detecting an RFID tag in proximity to a casino game whether or not the individual plays the game.

11. A method according to claim 10 further including recording the individual's game playing history by determining the proximity to a casino game of a RFID tag carried by the individual.

12. A method according to claim 10 further including altering game play for an individual in response to detecting an individual at a game based on detecting a RFID tag.

13. A method according to claim 10 further wherein the casino game is at least in part an electronically controlled game.

14. A method according to claim 10 further wherein the RFID tag is mounted in a token or card an individual uses in connection with playing a casino game.

15. A method according to claim 10 further including situating the RFID tag reader behind a glass surface of a casino game.

16. A method according to claim 10 further including situating the reader device in the casino game in order to facilitate RF radiation traversing the game housing.

17. A method according to claim 10 further including situating the RFID tag reader on the top of a casino game.

18. A method according to claim 10 further including maintaining an information system receiving information derived from the reader components in the gaming establishment, wherein the information system provides for:
recording information concerning the movement and activities of an individual in a gaming establishment as determined from reading individual RFID tags by the reader components; and
altering the play of one or more casino games in response to the detection of a particular individual at a game.

19. A method according to claim 9 wherein the data transmission method comprises physical connectors connecting the information method to the reader components.

20. A method according to claim 9 wherein the data transmission method comprises RF transmission components passing data between the reader components and the information method using radio frequency transmissions.

21. A method according to claim 9 wherein the reader component is an antenna.

22. A method according to claim 21 further including a reader unit receiving input from the antenna.

23. A method according to claim 22 further wherein the reader unit is located in the casino game.

24. A method according to claim 22 further wherein the reader unit is located outside of the casino game.

25. A method according to claim 21 further including a reader unit receiving input from a plurality of antennas wherein the antennas are located in two or more different casino games.

26. A system comprising:
a RFID tag carried by an individual in a gaming establishment; and
a casino game including a reader component that detects a RFID tag in proximity to the reader component wherein the reader component is capable of receiving information from the RFID tag.

27. A system according to claim 26 further including a network connection that carries information from a reader component to an information system.

28. A system according to claim 26 further including a RF connection for carrying information from the reader component to an information system.

29. A system according to claim 26 further including an information system including software operable on the system to record information concerning the movement and activities of an individual in a gaming establishment as determined from reading RFID tags by the reader components.

30. A system according to claim 29 further including the software operable on the system to alter the play of one or more casino games in response to the detection of a particular individual at a game.

31. A system according to claim 29 further including the software operable on the system recording the individual's game playing history.

32. A system according to claim 29 further including the software operable on the system altering game play for an individual in response to detecting the individual at the game by detecting a RFID tag.

33. A system according to claim 29 further wherein the casino game is at least in part an electronically controlled game.

34. A system according to claim 29 further including the software operable on the system the RFID tag being part of a token or card an individual uses in connection with playing a casino game.

35. A system according to claim 29 further wherein the reader component is mounted in the casino game to facilitate RF radiation traversing the game housing.

36. A system according to claim 29 further including the software operable on the system situating the RFID tag reader on the top of a casino game.

37. A system according to claim 26 wherein the data transmission system comprises physical connectors connecting the information system to the reader components.

38. A system according to claim 26 wherein the data transmission system comprises RF transmission components passing data between the reader components and the information system using radio frequency transmissions.

39. A system according to claim 26 wherein the reader component is an antenna.

40. A system according to claim 39 further including a reader unit receiving input from the antenna.

41. A system according to claim 40 further wherein the reader unit is located in the casino game.

42. A system according to claim 40 further wherein the reader unit is located outside of the casino game.

43. A system according to claim 39 further including a reader unit receiving input from a plurality of antennas wherein the antennas are located in two or more different casino games.

44. A system comprising:
a plurality of casino games located in gaming establishment wherein at least some of the games include a reader component that detects a RFID tag in proximity to the reader component;
at least some of the games carrying RFID tags;
wherein the reader component receives information from a RFID tag in the gaming establishment;
an information system including software operable on the system to record information concerning the location of a game in a gaming establishment as determined from reading a RFID tag carried by one of the casino games.

45. A method comprising:
positioning a RFID tag with a casino game in a gaming establishment; and
using a reader component situated in or near a casino game to detect a RFID tag in proximity to the casino game and in turn determine the proximity of a casino game associated with the RFID tag.

46. A method according to claim 45 further including altering game play for a game in response to detecting another game in proximity thereto.

47. A method according to claim 45 further wherein the casino game is at least in part an electronically controlled game.

48. A method according to claim 45 further including situating the reader component in the casino game in order to facilitate RF radiation traversing the game housing.

49. A method according to claim 45 further including situating the RFID tag reader on the top of a casino game.

50. A method according to claim 45 further including maintaining an information system receiving information derived from the reader components in the gaming establishment, wherein the information system provides for:
recording information concerning a position of a game in a gaming establishment as determined from reading individual RFID tags by the reader components;
altering the play of one or more casino games in response to the detection of a particular game.

51. A method according to claim 45 further wherein the reader component is located in the casino game.

52. A method according to claim 45 further wherein the reader component is located outside of the casino game.

53. A method according to claim 45 further wherein the reader component includes a reader unit receiving input from a plurality of antennas wherein the antennas are located in two or more different casino games.

54. A system comprising:
a RFID tag fastened in or on a casino game in a gaming establishment; and
a casino game including a reader component that receives information from the RFID tag when in proximity to the reader component.

55. A system according to claim 54 further including an information system including software operable on the system to:
record information concerning the position of a game in a gaming establishment as determined from reading by the reader component RFID tags fastened in or on casino games.

56. A system according to claim 55 further including the software operable on the system to alter the play of one or more casino games in response to the detection of a particular game in proximity thereto.

57. A system according to claim 55 further wherein the RFID tag is mounted in the casino game to facilitate RF radiation traversing the game housing.

58. A method according to claim 55 further wherein the RFID tag is mounted on the top of a casino game.

59. A system comprising:
a plurality of casino games located in a gaming establishment having one or more reader components positioned therein, wherein the reader components are adapted to detect a RFID tag in proximity to the reader component and read data from the RFID tag, wherein the RFID tag is carried by an individual in the gaming establishment; and
an information system including software operable on the system to record information concerning the movement and activities of an individual in a gaming establishment as determined from reading the RFID tag carried by the individual in the gaming establishment.

60. A system according to claim 59 wherein the reader component is an antenna.

61. A system according to claim 60 further wherein the reader component includes a reader unit receiving input from the antenna.

62. A system according to claim 59 further wherein the reader unit is located in the casino game.

63. A system according to claim 59 further including a reader unit receiving input from a plurality of antennas wherein the antennas are located in two or more different locations.

64. A method comprising:
providing a RFID tag to an individual in a gaming establishment;
the individual carrying the RFID tag with him or her as they move about or play games in the gaming establishment; and
using a RFID tag reader component situated in the gaming establishment to receive information from the RFID tag.

65. A method according to claim 64 further including detecting an RFID tag in proximity to a casino game in the gaming establishment.

66. A method according to claim 64 further including recording the individual's game playing history by determining the proximity to a casino game of a RFID tag carried by the individual.

67. A method according to claim 64 further including altering game play for an individual in response to detecting an individual at a game based on detecting a RFID tag.

68. A method according to claim 64 further wherein the casino game is at least in part an electronically controlled game.

69. A method according to claim 64 further wherein the RFID tag is mounted in a token or card an individual uses in connection with playing a casino game.

70. A method according to claim 64 further including situating the reader device in the casino game in order to facilitate RF radiation traversing the game housing.

71. A method according to claim 64 further including situating the RFID tag reader on the top of a casino game.

72. A method according to claim 64 further including maintaining an information system receiving information derived from the reader components in the gaming establishment, wherein the information system provides for:
recording information concerning the movement and activities of an individual in a gaming establishment as determined from reading individual RFID tags by the reader components; and
altering the play of one or more casino games in response to the detection of a particular individual at a game.

73. A system comprising:
a RFID tag carried by an individual in a gaming establishment; and
a plurality of reader components positioned in the gaming establishment that detect a RFID tag in proximity to the reader component wherein the reader component is capable of receiving information from the RFID tag.

74. A system according to claim 73 further including an information system including software operable on the system to record information concerning the movement and activities of an individual in a gaming establishment as determined from reading RFID tags by the reader components.

75. A system according to claim 74 further including the software operable on the system to alter the play of one or more casino games in response to the detection of a particular individual at a game.

76. A system according to claim 75 further including the software operable on the system recording the individual's game playing history.

77. A system according to claim 75 further including the software operable on the system altering game play for an individual in response to detecting the individual at the game by detecting a RFID tag.

78. A system according to claim 75 further wherein the casino game is at least in part an electronically controlled game.

79. A system comprising:
a plurality of casino games located in gaming establishment wherein the establishment includes a plurality of reader components that detect a RFID tag in proximity to the reader component;
at least some of the games carrying RFID tags;
wherein the reader component receives information from a RFID tag in the gaming establishment;
an information system including software operable on the system to record information concerning the location of a game in a gaming establishment as determined from reading a RFID tag carried by one of the casino games.

80. A method comprising:
positioning a RFID tag with a casino game in a gaming establishment; and
using a reader component situated in the gaming establishment to detect a RFID tag in proximity to the reader and in turn determine the proximity of a casino game associated with the RFID tag.

81. A system comprising:
a RFID tag fastened in or on a casino game in a gaming establishment; and
the establishment including a reader component positioned therein that receives information from the RFID tag when in proximity to the reader component.
